(19) United States
(12) Patent Application Publication
(10) Pub. No.: US 2004/0228682 A1
(43) Pub. Date: Nov. 18, 2004

(54) Securing device for securing engagement between a stem and steering tube of a bicycle

(76) Inventors: Ming-Hung Chen, Taichung Hsien (TW); Jin-Long Lee, Taichung Hsien (TW)

Correspondence Address: Dennison, Schultz & Dougherty, 612 Crystal Square 4, 1745 Jefferson Davis Highway, Arlington, VA, 22202-3417, US

(21) Appl. No.: 10/677,312

(22) Filed: Oct. 3, 2003

(30) Foreign Application Priority Data
May 14, 2003 (TW) 092208745

(51) Int. Cl. F16B 2/14

(52) U.S. Cl. 403/374.2

(57) ABSTRACT

A securing device for securing engagement between a stem and a steering tube of a bicycle includes a cap for engaging with distal ends of a clamping tube of the stem and the steering tube, a securing element movably received in the steering tube, an abutting element deformably received between the cap and the clamping tube for engagement with an inner periphery of the steering tube so as to force the steering tube to securely engage with the clamping tube of the stem and a bolt extending through the cap, the abutting element and the securing element for driving the securing element to move so as to force the abutting element to deform inside the steering tube. Thus engagement between the steering tube and the clamping tube is secured after the expansion of the two legs of the abutting element.

### BACKGROUND OF THE INVENTION

1. Field of the Invention

The present invention relates to a securing device, and more particularly to a securing device received in the steering tube to force the steering tube to expand so as to secure engagement between the steering tube and a stem of a bicycle.

2. Description of Related Art

With reference to FIGS. 5 and 6, a conventional securing device (70) for securing engagement between a steering tube (60) and a stem (50) is shown, wherein the stem (50) includes a tube (51) and a C-shaped clamping tube (52) securely formed with the tube (51). It should be appreciated that the head tube of the bicycle is omitted for clarity and thus the interconnecting relationship between the steering tube and the handlebar stem (50) is clear.

The securing device (70) is composed of a cap (71), a C-shaped sleeve (72), a bolt (73) and a conical plug (74).

When the steering tube (60) is extended into the clamping tube (52), a flange (61) formed on the steering tube (60) stops further extension of the steering tube (60) into the clamping tube (52). Then, the conical plug (74) and the sleeve (72) are sequentially inserted into the steering tube (60). Thereafter, the bolt (73) is applied to extend through the cap (71) to threadingly connect to the conical plug (74). In the meantime, the cap (71) securely engages with the distal ends of the sleeve (72), the steering tube (60) and the clamping tube (52).

When the bolt (73) is rotated, the conical plug (74) is forced to move toward the cap (71). Due to the cone shape design of the plug (74), movement of the conical plug (74) forces the C-shaped sleeve (72) to expand so that the steering tube (60) engages with the clamping tube (52) firmly.

However, the movement of the conical plug (74) to force the expansion of the sleeve (72) to secure the engagement between the steering tube (60) and the clamping tube (52) is, after all, circumstantial for the engagement between the steering tube (60) and the clamping tube (52). Besides, after a long period of time having the conical plug (74) received in the sleeve (72), corrosion and constant vibration of the bicycle eventually damage the conical plug (74), which results in that the engagement between the steering tube (60) and the clamping tube (52) is not secured and a rider's safety is at risk.

To overcome the shortcomings, the present invention tends to provide an improved securing device to mitigate the aforementioned problems.

### SUMMARY OF THE INVENTION

The primary objective of the present invention is to provide an improved securing device to secure engagement between the steering tube and the stem of a bicycle, wherein an abutting element is able to have a surface contact with the steering tube such that the engagement between the steering tube and the clamping tube is solid.

Another objective of the present invention is that when adjusting the deformation of the abutting element, a stop formed on a top face of a securing element engages with distal ends of the abutting element such that rotation of the securing element is avoided.

Other objects, advantages and novel features of the invention will become more apparent from the following detailed description when taken in conjunction with the accompanying drawings.

### BRIEF DESCRIPTION OF THE DRAWINGS

FIG. 1 is perspective view of the securing device of the present invention;

FIG. 2 is an exploded perspective view of the securing device of the present invention;

FIG. 3 is schematic view showing the application of the securing device of the present invention between the steering tube and the stem;

FIG. 4 is a schematic view showing the abutting element is forced to expand to securely engage the steering tube with the stem;

FIG. 5 is an exploded perspective view of a conventional securing device for a stem and a steering tube of a bicycle; and

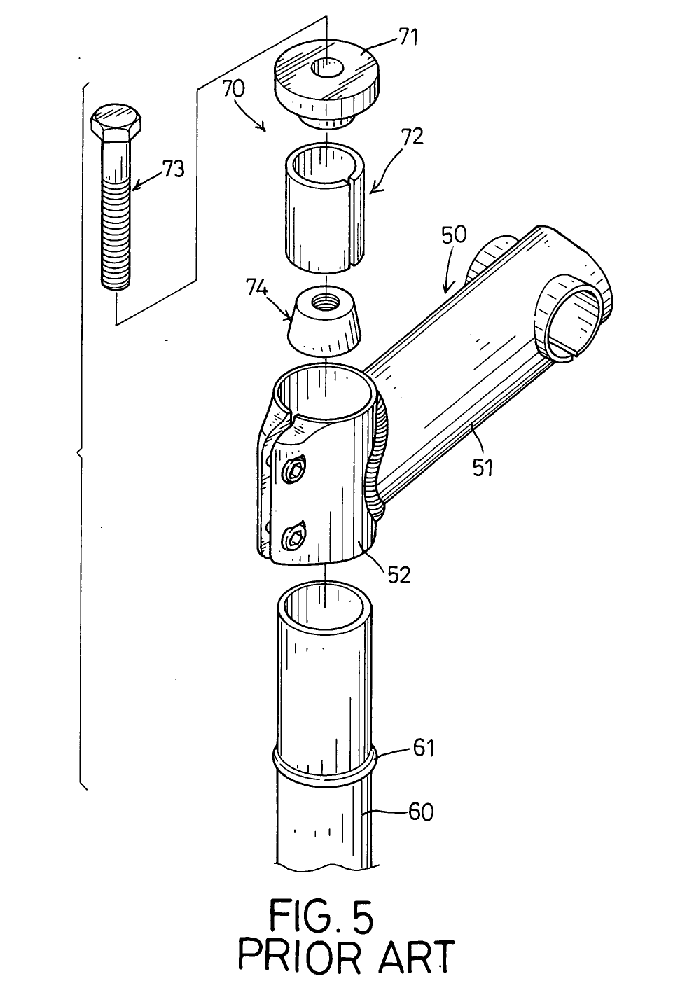

FIG. 6 is a schematic view showing the application of the conventional securing device between the steering tube and the stem.

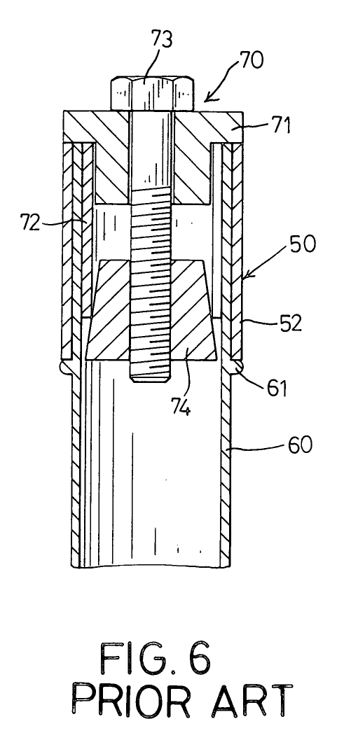

### DETAILED DESCRIPTION OF THE PREFERRED EMBODIMENT

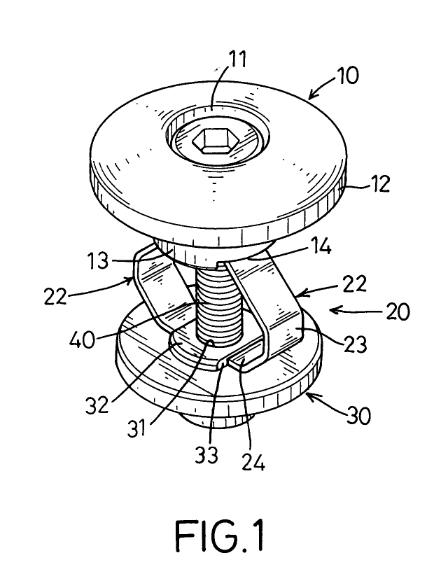

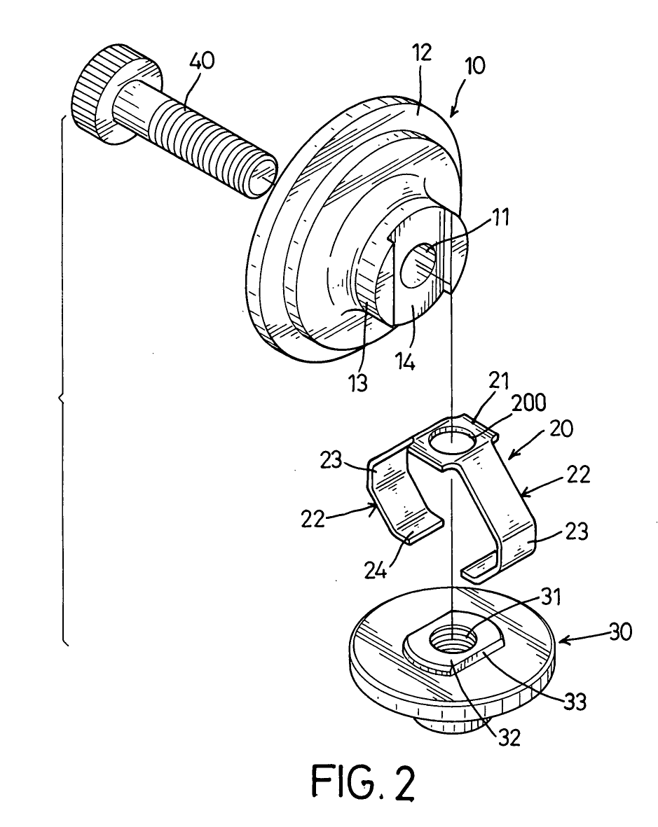

With reference to FIGS. 1 and 2, the securing device in accordance with present invention is shown to have a cap (10), an abutting element (20), a securing element (30) and a locking element (40).

The cap (10) has a first extension (12) formed on a bottom face of the cap (10), a second extension (13) formed on a bottom face of the first extension (12), and a through hole (11) defined through the cap (10), the first extension (12) and second extension (13). A positioning recess (14) is defined in a bottom face of the second extension (13).

The abutting element (20) has a top board (21) with a first hole (200) corresponding to the through hole (11) of the cap (10) and two legs (22) oppositely extending out from the top board (21). Each leg (22) has an abutting face (23) perpendicular to the top board and a hook (24) formed on a distal end of the leg (22).

The securing element (30) has a second hole (31) corresponding to the first hole (200) and a stop (32) formed on a top face of the securing element (30) and having two truncated side faces (33) respectively and oppositely formed on sides of the stop (32) to correspond to the two hooks (24) of the abutting element (20). The locking element (40), preferably a bolt, is extended through the through hole (11) of the cap (10), the first hole (200) of the abutting element (20) and into the second hole (31) of the securing element (30) to threadingly connect to the securing element (30). Before securing engagement among the cap (10), the abutting element (20) and the securing element (30), it is noted that the top board (21) is received in the positioning recess (14) to allow the through hole (11) to mate with the first hole (200). The top board (21) is so configured that after the top board (21) is received in the positioning recess (14) of the cap (10), there is no relative movement between the cap (10) and the abutting element (20). Furthermore, the two hooks (24) respectively engage with the two truncated side faces (33) of the stop (32). Therefore, under the dual limitation of the cap (10) and the securing element (30), the abutting element (20) will not rotate relative to both the cap (10) and the securing element (30).

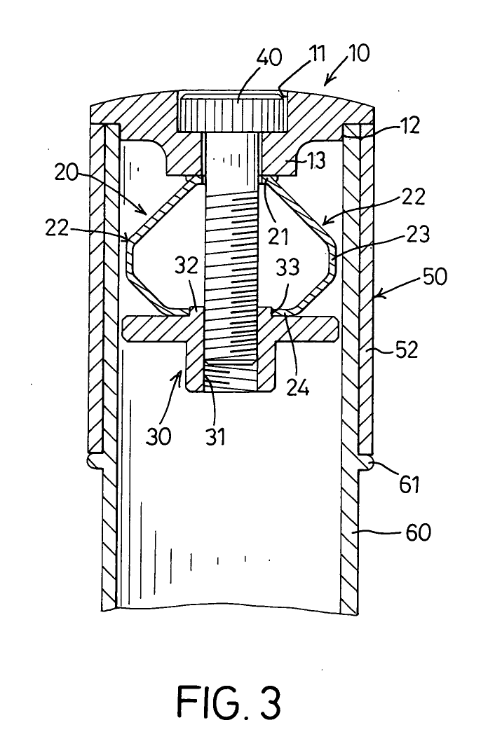

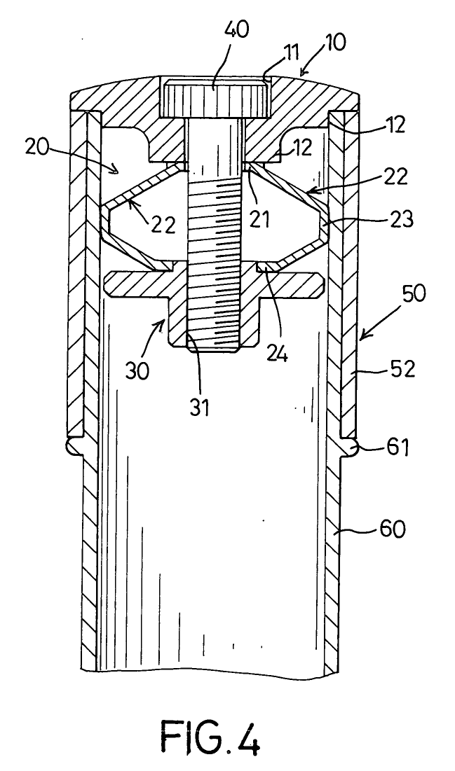

With reference to FIGS. 3 and 4, it is noted that the handlebar stem (or stem) (50) and the steering tube (60) are still using the same reference numerals as those used in the background description because both the stem (50) and the steering tube (60) are elements to work with the securing device of the present invention. Using the same reference numerals will facilitate understanding the advantages of the present invention and drawbacks of the prior art. Furthermore, the head tube of the bicycle is omitted for clarity and thus the interconnecting relationship between the steering tube and the stem (50) is clear.

When the securing device of the present invention is employed to the stem (50) and the steering tube (60) which is received in the stem (50) and the flange (61) of the steering tube (60) stops further extension of the steering tube (60) into the clamping tube (52), the securing device is first received in the steering tube (60) and a face located at a joint between the first extension (12) and the cap (10) engages with distal ends of both the clamping tube (52) and the steering tube (60) so that the cap (10) functions as a plug to both the clamping tube (52) and the steering tube (60).

When the locking element (40) is rotated, the securing element (30) then gradually ascends toward the cap (10). Because the abutting element (20) is limited by both the positioning recess (14) and the truncated side faces (33), the abutting element (20) will not rotate along with the locking element (40). Therefore, the abutting element (20) is deformed between the second extension (13) of the cap (10) and the securing element (30) when the securing element (30) is moving upward due to the rotation of the locking element (40).

While the abutting element (20) is deformed to have the two legs (22) expanded between the cap (10) and the securing element (30), the two abutting faces (23) of the abutting element (20) abut an inner periphery of the steering tube (60) at opposite locations so as to force the steering tube (60) to expand to have a tight engagement with the clamping tube (52), as shown in FIG. 4.

Because of the abutting faces (23) of the abutting element (20), the contact between the abutting element (20) is a broad surface contact instead of a point contact as used in the conventional securing device. Furthermore, the expansion of the steering tube (60) will be much more even due to the abutting faces (23) so as to have a full scale contact with the clamping tube (52). Another advantage of the present invention is that when the abutting element (20) does not have the ability to expand further, the cap (10) will be forced to move toward the securing element (30) at the final stage for securing the engagement between the steering tube (60) and the clamping tube (52), which further limits the movement of the clamping tube (52) to prevent the clamping tube from coming off from the steering tube (60).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A securing device for securing engagement between a stem and a steering tube which is received in the stem, of a bicycle, the securing device comprising:
a cap engageable with distal ends of both a clamping tube of the stem and the steering tube;
a securing element movably received in the steering tube;
an abutting element deformably received between the cap and the clamping tube for engagement with an inner periphery of the steering tube so as to force the steering tube to securely engage with the clamping tube of the stem; and
means for driving the securing element to move so as to force the abutting element to deform inside the steering tube.

2. The securing device as claimed in claim 1, wherein the abutting element has two legs oppositely extending outward from a top board and each leg having an abutting face perpendicularly formed relative to the top board for engagement with the inner periphery of the steering tube.

3. The securing device as claimed in claim 1, wherein the cap has a through hole defined through a first extension formed on a bottom face of the cap and a second extension formed on a bottom face of the first extension.

4. The securing device as claimed in claim 2, wherein the cap has a through hole defined through a first extension formed on a bottom face of the cap and a second extension formed on a bottom face of the first extension.

5. The securing device as claimed in claim 4, wherein a limiting recess is defined in a bottom face of the second extension to correspond to the top board so that the top board is able to be received and limited in the limiting recess.

6. The securing device as claimed in claim 5, wherein each leg has a hook formed on a free end of the leg.

7. The securing device as claimed in claim 1, wherein the securing element has a stop formed on a top face of the securing element and having two truncated side faces respectively and oppositely formed on a periphery of the stop.

8. The securing device as claimed in claim 2, wherein the securing element has a stop formed on a top face of the securing element and having two truncated side faces respectively and oppositely formed on a periphery of the stop.

9. The securing device as claimed in claim 4, wherein the securing element has a stop formed on a top face of the securing element and having two truncated side faces respectively and oppositely formed on a periphery of the stop.

10. The securing device as claimed in claim 6, wherein the securing element has a stop formed on a top face of the securing element and having two truncated side faces respectively and oppositely formed on a periphery of the stop such that the two hooks of the abutting element are able to respectively engage with a corresponding one of the truncated side faces and thus the abutting element is limited by the securing element.

11. The securing device as claimed in claim 4, wherein the abutting element has a first hole corresponding to the through hole of the cap and the securing element has a second hole corresponding to the first hole such that the driving means is able to extend through the through hole, the first hole and into the second hole to drive the securing element to move toward the cap and to force the two legs of the abutting element to expand for engagement with the inner periphery of the steering tube.

12. The securing device as claimed in claim 5, wherein the abutting element has a first hole corresponding to the through hole of the cap and the securing element has a second hole corresponding to the first hole such that the driving means is able to extend through the through hole, the first hole and into the second hole to drive the securing element to move toward the cap and to force the two legs of the abutting element to expand for engagement with the inner periphery of the steering tube.

13. The securing device as claimed in claim 9, wherein the abutting element has a first hole corresponding to the through hole of the cap and the securing element has a second hole corresponding to the first hole such that the driving means is able to extend through the through hole, the first hole and into the second hole to drive the securing element to move toward the cap and to force the two legs of the abutting element to expand for engagement with the inner periphery of the steering tube.

14. The securing device as claimed in claim 10, wherein the abutting element has a first hole corresponding to the through hole of the cap and the securing element has a second hole corresponding to the first hole such that the driving means is able to extend through the through hole, the first hole and into the second hole to drive the securing element to move toward the cap and to force the two legs of the abutting element to expand for engagement with the inner periphery of the steering tube.

15. The securing device as claimed in claim 1, wherein the driving means is a bolt to extend through the cap, the abutting element and into the securing element to threadingly connect to the securing element such that rotation of the bolt is able to drive the securing element to move toward the cap to deform the abutting element.

16. The securing device as claimed in claim 11, wherein the driving means is a bolt to extend through the cap, the abutting element and into the securing element to threadingly connect to the securing element such that rotation of the bolt is able to drive the securing element to move toward the cap to deform the abutting element and thus the two legs of the abutting element are able to expand for engagement with the inner periphery of the steering tube.

17. The securing device as claimed in claim 12, wherein the driving means is a bolt to extend through the cap, the abutting element and into the securing element to threadingly connect to the securing element such that rotation of the bolt is able to drive the securing element to move toward the cap to deform the abutting element and thus the two legs of the abutting element are able to expand for engagement with the inner periphery of the steering tube.

18. The securing device as claimed in claim 13, wherein the driving means is a bolt to extend through the cap, the abutting element and into the securing element to threadingly connect to the securing element such that rotation of the bolt is able to drive the securing element to move toward the cap to deform the abutting element and thus the two legs of the abutting element are able to expand for engagement with the inner periphery of the steering tube.

19. The securing device as claimed in claim 14, wherein the driving means is a bolt to extend through the cap, the abutting element and into the securing element to threadingly connect to the securing element such that rotation of the bolt is able to drive the securing element to move toward the cap to deform the abutting element and thus the two legs of the abutting element are able to expand for engagement with the inner periphery of the steering tube.
